(19) United States
(12) Patent Application Publication
(10) Pub. No.: US 2023/0060869 A1
(43) Pub. Date: Mar. 2, 2023

(54) SYSTEMS AND METHODS TO IMPLEMENT TRAINED INTELLIGENCE AGENTS FOR DETECTING ACTIVITY THAT DEVIATES FROM THE NORM

(71) Applicant: International Business Machines Corporation, Armonk, NY (US)

(72) Inventors: Brandon Harris, Union City, NJ (US); Chaz Vollmer, Raleigh, NC (US); Eugene Irving Kelton, Wake Forest, NC (US)

(21) Appl. No.: 17/465,367

(22) Filed: Sep. 2, 2021

(51) Int. Cl. G06Q 20/40; G06Q 10/06; G06Q 40/02

(52) U.S. Cl. CPC G06Q 20/4016; G06Q 10/067; G06Q 40/025

(57) ABSTRACT

A system, platform, computer programming product, and/or method includes providing a trained intelligent agents to predict simulated transactional activity of a simulated person; pairing a person to the trained intelligent agent based upon the transactional activity of the person; predicting, by the paired trained intelligent agent, simulated transactional activity of the simulated person for a measured period; scoring the simulated transactional activity for the measured period; scoring the transactional activity undertaken by the paired person for the measured period; determining if the score of the simulated transactional activity for the measured period is different than the score of the paired person transactional activity for the measured period; and generating, in response to determining that the score of the simulated transaction activity for the measured period is different than the score of the paired person transactional activity for the measured period, a report.

### TECHNICAL FIELD

The present invention relates generally to identification of a behavioral pattern and more particularly, to using cognitive analytics and trained intelligent agents or bots to detect suspicious activity and/or fraudulent transactions.

### BACKGROUND

Systems and methods have been developed that use cognitive analytics to help financial institutions detect suspicious activity indicative of money laundering, terrorist financing, and/or fraudulent activity. The cognitive analytics differentiate “normal” financial activities from “suspicious” activities and use the differentiation information to build a predictive model for financial institutions. One example of a financial crime detection system that uses cognitive analytics to help financial institutions detect suspicious financing is IBM^{®} Financial Crimes Alerts Insight with Watson™. Other cognitive analytical models and methods exist to attack and solve the problem of detecting suspicious financial activity indicative of money laundering, terrorist financing, and other fraudulent activity, and each have their merits and detriments. It would be advantageous to build an intelligent agent that uses cognitive analytics to detect suspicious activity and generate alerts in real time, or close to real time. It would be further advantageous to take trained agents or bots and rather than simulate new behavior, flag transactions and activity that is inconsistent with the intelligent agent’s behavior patterns (e.g., as set by confidence intervals) in or close to real time.

### SUMMARY

The summary of the disclosure is given to aid understanding of, and not with an intent to limit, the disclosure. The present disclosure is directed to a person of ordinary skill in the art. It should be understood that various aspects and features of the disclosure may advantageously be used separately in some circumstances or instances, or in combination with other aspects, embodiments, and/or features of the disclosure in other circumstances or instances. Accordingly, variations and modifications may be made to the system, platform, their architectural structure, and their method of operation to achieve different effects. In this regard it will be appreciated that the disclosure presents and describes one or more inventions, and in aspects includes numerous inventions as defined by the claims.

A system, platform, computer program product and/ or method of determining if transactional activity of a person (actual or representative person) deviates from the predicted simulated transactional activity as predicted by a trained intelligent agent, also referred to as a bot, preferably in or close to real time, is disclosed. In one or more embodiments, a system, platform, computer program product, and/or computer implemented method includes: providing one or more trained intelligent agents to predict simulated transactional activity of one or more simulated persons; pairing a person to one of the one or more trained intelligent agents based upon the transactional activity of the person; predicting, by the paired trained intelligent agent, simulated transactional activity of a simulated person for a measured period; scoring the simulated transactional activity of the simulated person for the measured period; scoring the transactional activity undertaken by the paired person for the measured period; determining if the score of the simulated transactional activity of the simulated person for the measured period is different than the score of the transactional activity undertaken by the paired person for the measured period; and generating, in response to determining that the score of the simulated transaction activity of the simulated person for the measured period is different than the score of the transactional activity undertaken by the paired person for the measured period, a report. In an aspect, the person paired to one of the trained intelligent agents is a representative person, wherein the representative person comprises a plurality of actual persons that are clustered based upon the transactional activity of the plurality of actual persons via hyper-dimensional clustering. Scoring the simulated transactional activity of the simulated person for the measured period and scoring the transactional activity undertaken by the paired person for the measured period, in one or more embodiments, are performed using the policy engine of the paired intelligent agent.

In one or more embodiments, determining if the score of the simulated transaction activity of the simulated person for the measured period is different than the score of the transactional activity undertaken by the paired person for the measured period comprises determining if the score of the simulated transactional activity of the simulated person for the measured period is different by at least a threshold from the score of the transactional activity undertaken by the paired person for the measured period. The threshold according to one or more implementations is at least one of the group consisting of: a selectable threshold, a programmable threshold, an adjustable threshold, a fixed threshold, a predefined threshold, a predetermined threshold, and combinations thereof, and in an implementation, The threshold is a risk threshold determined by a risk policy, e.g., a financial institution’s risk policy.

According to one or more embodiments, the system, platform, computer program product, and/or method, after determining if the score of the simulated transactional activity of the simulated person for the measured period is different than the score of the transactional activity undertaken by the paired person for the measured period, further includes: predicting, by the paired trained intelligent agent paired, the simulated transactional activity of the simulated person for a second measured period; scoring the simulated transactional activity of the simulated person for the second measured period; scoring the transactional activity undertaken by the paired person for the second measured period; determining if the score of the simulated transactional activity of the simulated person for the second measured period is different than the score of the transactional activity undertaken by the paired person for the second measured period; and generating, in response to determining that the score of the simulated transactional activity of the simulated person for the second measured period is different than the score of the transactional activity undertaken by the paired person for the second measured period, a report.

The foregoing and other objects, features, and/or advantages of the invention will be apparent from the following more particular descriptions and exemplary embodiments of the invention as illustrated in the accompanying drawings wherein like reference numbers generally represent like parts of the illustrative embodiments of the invention.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. The claims should not be limited to the precise arrangement, structures, features, aspects, systems, platforms, architectures, modules, functional units, assemblies, subassemblies, systems, circuitry, embodiments, methods, processes, techniques, devices and/or details shown, and the arrangements, structures, systems, platforms, architectures, modules, functional units, assemblies, subassemblies, features, aspects, methods, processes, techniques, circuitry, embodiments, devices and/or details shown may be used singularly or in combination with other arrangements, structures, assemblies, subassemblies, systems, platforms, architectures, modules, functional units, features, aspects, circuitry, embodiments, methods, techniques, processes, devices and/or details. Included in the drawings are the following Figures:

FIG. 1 depicts a schematic diagram of one illustrative embodiment of a cognitive system 100 implementing transaction data simulator, and behavioral pattern comparator;

FIG. 2 depicts a schematic diagram of one illustrative embodiment of a transaction data simulator 110;

FIG. 3 depicts a schematic diagram showing a plurality of simulated transactions from a simulated customer, according to embodiments herein;

FIG. 4 illustrates a flow chart of one illustrative embodiment of a method 400 of training an intelligent agent;

FIG. 5 illustrates a flow chart of one illustrative embodiment showing a method 500 of identifying a fraudulent behavioral pattern;

FIG. 6 is a block diagram of an example data processing system 600 in which aspects of the illustrative embodiments may be implemented.

### DETAILED DESCRIPTION

The following description is made for illustrating the general principles of the invention and is not meant to limit the inventive concepts claimed herein. In the following detailed description, numerous details are set forth in order to provide an understanding of the system, method, and/or techniques for monitoring and detecting suspicious financial activity, e.g., money laundering, however, it will be understood by those skilled in the art that different and numerous embodiments of the system and its method of operation may be practiced without those specific details, and the claims and disclosure should not be limited to the features, aspects, arrangements, structures, systems, assemblies, subassemblies, platforms, architectures, modules, functional units, circuitry, embodiments, processes, methods, techniques, and/or details specifically described and shown herein. Further, particular features, aspects, arrangements, structures, systems, assemblies, subassemblies, platforms, architectures, modules, functional units, circuitry, embodiments, methods, processes, techniques, details, etc. described herein can be used in combination with other described features, aspects, arrangements, structures, systems, assemblies, subassemblies, platforms, architectures, modules, functional units, circuitry, embodiments, techniques, methods, processes, details, etc., in each of the various possible combinations and permutations.

The following discussion omits or only briefly describes conventional features of information processing systems and data networks, including electronic data analytics programs or electronic risk assessment tools configured and adapted to monitor and detect suspicious financial activity, which should be apparent to those skilled in the art. It is assumed that those skilled in the art are familiar with data extraction, cleaning, transforming, and processing, as well as data analytics including large scale cognitive analytics and their operation, and the application of cognitive analytics, including analytic systems and processes to monitor and detect suspicious financial activity. It may be noted that a numbered element is numbered according to the figure in which the element is introduced, and is typically referred to by that number throughout succeeding figures.

As an overview, a cognitive system is a specialized computer system, or set of computer systems, configured with hardware and/or software logic (in combination with hardware logic upon which the software executes) to emulate human cognitive functions. These cognitive systems apply human-like characteristics to convey and manipulate data at various levels of interpretation which, when combined with the inherent strengths of digital computing, can solve problems with high accuracy and resilience on a large scale. IBM Watson™ is an example of one such cognitive system which can process human readable language and identify inferences between text passages with human-like accuracy at speeds far faster than human beings and on a much larger scale. In general, such cognitive systems are able to perform the following functions:
Navigate the complexities of human language and understanding
Ingest and process vast amounts of structured and unstructured data
Generate and evaluate hypotheses
Weigh and evaluate responses that are based only on relevant evidence
Provide situation-specific advice, insights, and guidance
Improve knowledge and learn with each iteration and interaction through machine learning processes
Enable decision making at the point of impact (contextual guidance)
Scale in proportion to the task
Extend and magnify human expertise and cognition
Identify resonating, human-like attributes and traits from natural language
Deduce various language specific or agnostic attributes from natural language
High degree of relevant recollection (memorization and recall) from data points (images, text, voice)
Predict and sense with situation awareness that mimics human cognition based on experiences
Answer questions based on natural language and specific evidence

In one aspect, the cognitive system techniques can be applied to create a transaction data simulator, which can simulate a set of customer transaction data from a financial institution, e.g., a bank. The simulated customer transaction data, even if it is not “actual” customer transaction data from the financial institution, can be used to train the predictive model for identifying suspicious activity indicative of financial crimes. Raw or real customer transaction data can also be used to train, tune, or validate the predictive model, e.g., the trained intelligent agent.

The transaction data simulator combines a multi-layered unsupervised clustering approach with a semi-interactive reinforcement learning (IRL) model to create a large set of intelligent agents, also referred to as “trained bots”, that have learned to behave like a wide range of “financial institution customers.”

In an embodiment, the multi-layered unsupervised clustering approach creates a large set of varying representative sets of customer transactions (e.g., extracted from real customer transaction data provided by a financial institution), using information including hundreds of attributes of customers over varying lengths of time. Each set of the sets of customer transactions can be associated with a group of customers having similar transaction characteristics. An intelligent agent or trained bot, in an embodiment generates an artificial customer profile, and selects one of the sets of customer transactions to be combined with the generated artificial customer profile. In this way, the intelligent agent or trained bot can simulate that set of customers and learn to behave as though it were a customer that would fit within that same set of customers. The intelligent agent or trained bot is then provided with a period of time (e.g., five years), during which the intelligent agent can observe customer behavior within a controlled environment, e.g., past behaviors of the represented set of customers and learn to perform “simulated” customer transactions which are similar to standard transactions (behavior) of the represented set of customers.

The sets of customer transactions in one or more embodiments can include a number of factors, where the factors can be statistic data or otherwise arithmetically derived data. For example, the transaction amount of a particular product and account of the set of customer transactions can be a set value or represented as a range of values, e.g., the transaction amount of the sets of customer transactions is $20-$3,000. The transaction location of a sets of customer transactions can be provided statistically, e.g., 30% of transaction locations are shopping malls, 50% of transaction locations are restaurants, and 20% of transaction locations are gas stations. The transaction type of a set of customer transactions can be provided statistically, e.g., 20% of transaction types are check payment, 40% of transaction types are POS payment, 25% of transaction types are ATM withdrawal, and 15% of transaction types are wire transfer. The transaction medium of a set of customer transactions can be provided statistically, e.g., 15% of transaction mediums are cash, 45% of transaction mediums are credit card, 25% of transaction mediums are checking accounts, and 15% of transaction mediums are PayPal^{®}.

In an embodiment, a large number of artificial customer profiles are generated from a plurality of real customer profile data. The real customer profile data can be provided by one or more banks. Each real customer profile can include an address of a customer; a name of a customer (the customer can be a legal entity or individual); contact information such as a phone number, an email address, etc.; credit information, such as a credit score, FICO score, a credit report, etc.; income information (e.g., an annual revenue of a legal entity, or a wage of an individual), and the like. The real customer profile data is stored under different categories. For example, commercial customers (i.e., legal entities) can be divided into different categories based on the size, product, or service of the commercial customers. An artificial customer profile can be generated by randomly searching all the real customer profile data. For example, an artificial customer profile can be generated by combining randomly selected information including address, first name, second name, phone number, email address, credit score, revenue or wage, etc. Thus, the generated artificial customer profile extracts different pieces of information from real customer profile data, and thus looks like a realistic customer profile. Financial transaction data is further simulated and associated with each artificial customer profile. In an embodiment, the simulated customer transaction data can be combined with an artificial customer profile to form simulated customer data.

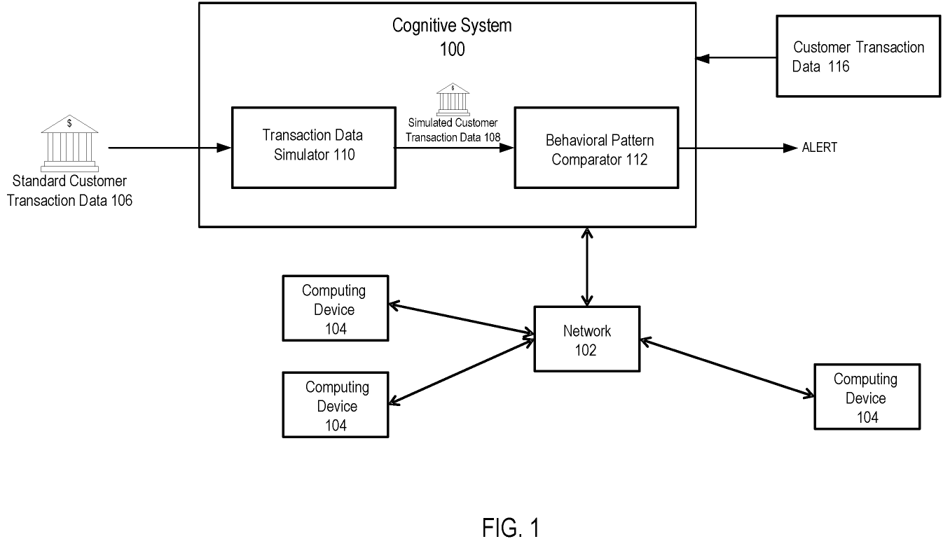

FIG. 1 depicts a schematic diagram of one illustrative embodiment of a cognitive system 100 implementing transaction data simulator 110, and a behavioral pattern comparator 112. The cognitive system 100 is implemented on one or more computing devices 104 (comprising one or more processors and one or more memories, and potentially any other computing device elements generally known in the art including buses, storage devices, communication interfaces, and the like) connected to computer network 102. The computer network 102 typically includes multiple computing devices 104 in communication with each other and with other devices or components via one or more wired and/or wireless data communication links, where each communication link comprises one or more of wires, routers, switches, transmitters, receivers, or the like. Other embodiments of the cognitive system 100 may be used with components, systems, sub-systems, and/or devices other than those that are depicted herein. The computer network 102 can include local network connections and remote connections in various embodiments, such that the cognitive system 100 can operate in environments of any size, including local and global environments, e.g., through the Internet.

The cognitive system 100 in one or more embodiments is configured to implement transaction data simulator 110 that can simulate or intake sets of customer transaction data 106 (i.e., a standard customer transaction behavior). In an embodiment, the cognitive system 100 and/or transaction data simulator 110 can intake sets of customer transaction data 116. The transaction data simulator 110 can generate a large set of simulated customer transaction data 108 based on the sets of customer transaction data 106, so that the simulated customer transaction data 108 looks like real customer transaction data. The translation data simulator 110 can generate a large set of simulated customer transaction data 108 based upon the sets of customer transaction data 116 and/or sets of customer transaction data 106. The simulated customer transaction data 108 in an embodiment is then combined with a randomly selected artificial customer profile, so that complete simulated customer profile data for a simulated customer is obtained.

In an embodiment, the sets of customer transaction data 106 is obtained through an unsupervised clustering approach. Raw customer data including a large amount of customer transaction data 116 is provided by one or more financial institutions, and a large number of small groups or sets representing different characteristics of financial institution customers are clustered or grouped from the raw customer data through an unsupervised clustering approach. Each small group or set includes transaction data from customers having similar characteristics. For example, group A represents customers who are single attorneys practicing patent law in New York, while group B represents customers who are married attorneys practicing commercial law in New York.

In an embodiment, a Behavioral Pattern Comparator 112 is also implemented on the Cognitive System 100. The Behavioral Pattern Comparator 112 can compare the simulated customer transaction data 108 provided by the transactional data simulator 110, and more particularly the predicted transactions (behavior) of a simulated customer as generated and/or represented by a trained intelligent agent, also referred to as a trained bot, can be compared to the activities and transactions of an actual person (e.g., customer) in or close to real time. For example, in one or more embodiments, a trained intelligent agent is paired to a person (a customer); the paired trained intelligent agent simulates or predicts new transaction records; the transactions (behavior) of the actual person (customer) are compared in the Behavior Pattern Comparator 112 to the transaction records predicted by the paired intelligent agent, and transactions by the person (customer) that are inconsistent with the predicted new transaction records by the trained intelligent agent are flagged for review.

In an aspect, trained intelligent agents are run to predict transactions of a person (a customer or clustered group of customers) in parallel with current person’s (customer) activity. Confidence levels or confidence intervals of the actual person’s transactions (e.g., the customer transactions/behavior) in one or more embodiments are compared to confidence intervals of simulated behavior generated, produced, and/or output by the trained intelligent agent, preferably in an embodiment in the Behavior Pattern Comparator 112. In an embodiment, if the confidence level of the paired actual person (customer) deviates from the confidence level of the behavior predicted by the paired, trained intelligent agent, then an alert can be generated that potentially suspicious activity has been detected. In an aspect, if the confidence levels of the paired actual person (customer) deviates from the confidence levels of the trained intelligence agent by a risk-based threshold, then an alert can be generated indicating that potentially suspicious activity has been detected for the paired actual person (customer).

The Behavior Pattern Comparator 112 has instructions, logic, and algorithms that when executed by a processor, cause the processor to perform the actions and operations discussed in connection with the Behavioral Pattern Comparator 112. While the Behavior Pattern Comparator 112 has been shown as a separate module in Cognitive System 110, it can be appreciated that Behavior Pattern Comparator 112, or the actions and/or functions performed by the Behavior Pattern Comparator 112 can be part of and/or integral with the Transaction Data Simulator 110.

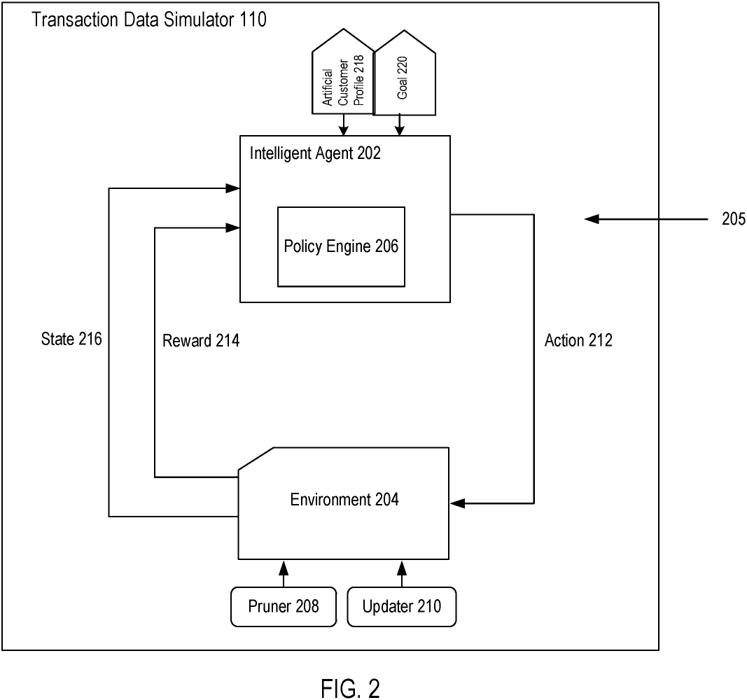

FIG. 2 depicts a schematic diagram of one illustrative embodiment of the Transaction Data Simulator 110. The transaction data simulator 110 utilizes reinforcement learning techniques to simulate financial transaction data. The transaction data simulator 110 includes intelligent agent 202, and environment 204. The intelligent agent 202 randomly selects a derived standard transaction behavior 220 (e.g., goal 220) representing a set of “people” having similar transaction characteristics, and associates the standard transaction behavior with a randomly selected artificial customer profile 218. The intelligent agent 202 outputs, determines, and/or takes an action 212 in each iteration. In this embodiment, the action 212 taken in each iteration includes determining whether any transactions will be conducted on a single day, e.g., twenty-four hours, and if so, conducts a plurality of transactions on that day. The iteration then continues onto the next day in the series. Each transaction has the transaction information including transaction type (e.g., Automated Clearing House (ACH) transfer, check payment, Wire transfer, Automated Teller Machine (ATM) withdrawal, Point of Sale (POS) payment, etc.); transaction amount; transaction time; transaction location; transaction medium (e.g., cash, credit card, debit card, PayPal^{®}, checking account, etc.); the second party who is related to the transaction (e.g., a person who receives the wire transferred payment), and the like.

The environment 204 takes the action 212 as input, and returns reward 214, also referred to as feedback, and state 216 from environment 204 as the output. The reward 214 is the feedback that measures the relative success or failure of the action 212. In an embodiment, the environment 204 compares the action 212 with goal 220 (e.g., standard transaction behavior). If the action 212 deviates from the goal 220 beyond a threshold, then the intelligent agent 202 is penalized, while if the action 212 deviates from the goal 220 within a threshold (i.e., the action 212 is similar to the goal 220), the intelligent agent 202 is rewarded. This can include even the decision by the intelligent agent as to whether or not to conduct any transactions on a given day. The threshold can be predefined, fixed, selectable, adjustable, programmable, and/or machine learned. The action 212 is effectively evaluated, so that the intelligent agent 202 can improve the next action 212 based on the reward 214. In this embodiment, the environment 204 is a set of all prior actions taken by the intelligent agent 202, i.e., the environment 204 is a set of all prior simulated transactions. The intelligent agent 202 observes the environment 204, and gets information about the prior transactions, e.g., the number of transactions that have been made within a day, a week, a month, or a year; each transaction amount, account balance, each transaction type, and the like. The policy engine 206 can adjust the policy based on the observations, so that the intelligent agent 202 can take a better action 212 in the next iteration.

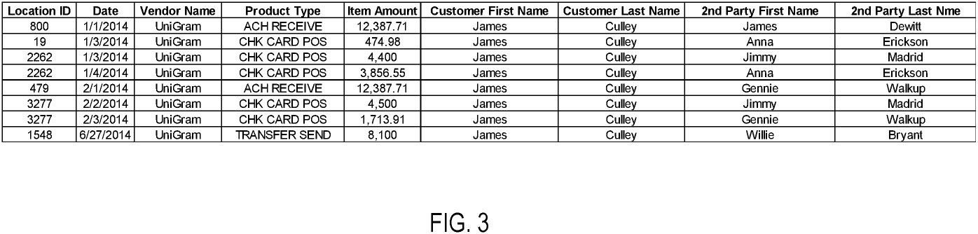

The intelligent agent 202 in an aspect includes policy engine 206, configured to adjust a policy based on the state 216 and the reward 214. The policy is a strategy that the intelligent agent 202 employs to determine the next action 212 based on the state 216 and the reward 214. The policy is adjusted, aiming to get a higher reward 214 for the next action 212 taken by the intelligent agent 202. The policy includes a set of different policy probabilities or decision-making probabilities which can be used to decide whether a transaction is going to be performed in a particular day or not, the number of transactions per day, transaction amount, transaction type, transaction party, etc. In reinforcement learning model, outcome of events are stochastic, and a random number generator (RNG) is a system that generates random numbers for use in the stochastic model. In an example, the maximum number of transactions per day is 100, and the maximum transaction amount is $15 million. In the first iteration, a random transaction with transaction amount of $15 million to Zimbabwe is made by the intelligent agent 202. This action 212 deviates far from the goal 220 (e.g., transaction made by married attorneys practicing commercial law in Maine), and thus this action 212 is penalized (i.e., the reward 214 is negative). The policy engine 206 is trained to adjust the policy, so that a different transaction which is closer to the goal 220 can be made. The use of RNG and a stochasitic model in reinforcement learning enables the policy to allow “exploration” by the intelligent agent, rather than getting “stuck” on generating simple transaction patterns that avoid penalties in the feedback system. With more iterations, transactions which are similar to the goal 220 can be simulated by the “smarter” policy engine 206. As shown in FIG. 3, a plurality of transactions from the customer “James Culley” are simulated, and the simulated transaction data is similar to the goal 220.

As shown in FIG. 2, in an embodiment, one feedback loop (i.e., one iteration) corresponds to one “day” of actions (i.e., one “day” of simulated transactions). During a period of time, e.g., ten years, the intelligent agent 202 learns how to take an action 212 to get a reward 214 as high as possible. The number of iterations corresponds to the duration of time. For example, ten years correspond to 10×365=3650 iterations. Semi-supervised human interaction 205 can observe and judge the actions 212 by the results that the actions 212 produce, at varying intervals, e.g., preset intervals of 10,000 iterations. It is goal 220 oriented, and its aim is to learn sequences of actions 212 that will lead the intelligent agent 202 to achieve its goal 220, or maximize its objective function.

In an embodiment, the transaction data simulator 110 further includes updater 210. A new action 212 is performed in each iteration. The updater 210 updates the environment 204 with the action 212 taken by the intelligent agent 202 after each iteration. The action 212 taken in each iteration is added into the environment 204 by the updater 210. In an embodiment, the transaction data simulator 110 further includes pruner 208, configured to prune the environment 204. In an embodiment, the pruner 208 can remove one or more undesired actions. For example, actions 212 which are taken in the first ten iterations are removed, because these ten iterations deviate far from the goal 220, and the degree of similarity is below a predefined threshold. In another embodiment, a full re-initialization of the transaction data simulator 110 can be performed to remove all the accumulated actions in the environment 204, so that the intelligent agent 202 can start over again.

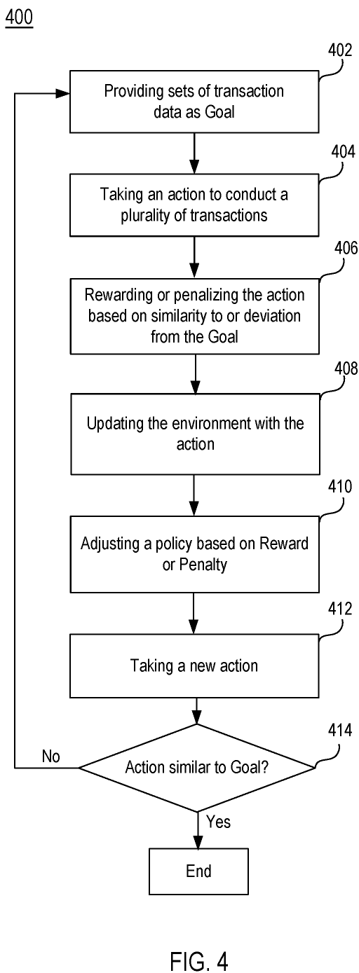

FIG. 4 illustrates a flow chart of one illustrative embodiment showing a method 400 of training an intelligent agent to produce simulated or predicted transaction data. While the method 400 is described for the sake of convenience and not with an intent of limiting the disclosure as comprising a series and/or a number of steps, it is to be understood that the process does not need to be performed as a series of steps and/or the steps do not need to be performed in the order shown and described with respect to FIG. 4, but the process may be integrated and/or one or more steps may be performed together, simultaneously, or the steps may be performed in the order disclosed or in an alternate order.

At step 402, sets of transaction data (e.g., customer transaction data) are provided as goal 220. The sets of transactions represents a group of people (customers) having similar transaction characteristics. The sets of customer transactions in an embodiment is obtained through an unsupervised clustering approach.

At step 404, an action 212 is taken to conduct a plurality of transactions in an iteration. Each iteration can represent a time period, e.g., a single day. Other time periods are contemplated. In a further embodiment, an action 212 is taken to conduction a number of transactions in an iteration, e.g., 100 transactions per iteration. Each transaction has the transaction information including transaction type, transaction amount, transaction time, transaction location, transaction medium, the second party who is associated with the transaction (if applicable), and the like.

At step 406, the environment 204 compares the goal 220 with the action 212 taken in this iteration, rewards or penalizes the action 212 based on its similarity to or deviation from the goal 220. The threshold or rule to decide whether the action 212 is similar to the goal 220 or not, is predefined, and can be adjusted based on how similar to the goal 220 the user prefers. The threshold can be predetermined, predefined, adjusted, fixed, programmable, and/or machine learned.

At step 408, the environment 204 is updated to include the action 212 in the present iteration. The environment 204 includes a set of all prior actions.

At step 410, the policy engine 206 adjusts a policy for determining the next action 212 based on the reward 214 (i.e., reward or penalty). The policy is made based on a variety of factors, e.g., probability of occurrence of a transaction, the number of transactions per day, transaction amount, transaction type, transaction party, transaction frequency of each transaction type, an upper bound and a lower bound for each transaction, transaction medium, and the like. The policy can adjust weights of these factors based on the reward 214 in each iteration.

At step 412, in a new iteration, the intelligent agent 202 takes a new action 212. The steps 404 to 412 are repeated until the action 212 is similar enough to the goal 220 (step 414). For example, the transaction amount specified in the goal 220 is $20-$3000. If the transaction amount of each transaction in the action 212 falls within the range of $20-$3000, then the action 212 is similar enough to the goal 220. A further optional step can include combining the artificial profile with the last action 212 including a plurality of transactions similar enough to the goal, so that simulated customer data is generated. In this manner a trained intelligent agent, e.g., a trained bot, is produced, generated, and/or produced.

Since the sets of (customer) transaction data 106 may include abnormal data, e.g., a fraudulent transaction, the simulated customer transaction data 108 may also include abnormal data, because the simulated customer transaction data 108 is similar to the sets of (customer) transaction data 106. In reinforcement learning model, the intelligent agent 202 explores the environment 204 randomly or stochastically, learns a policy from its experiences, and updates the policy as it explores to improve the behavior (i.e., transaction) of the intelligent agent 202. In an embodiment, a behavioral pattern (e.g., spending “splurges” until running out of savings, or experiencing “buyer’s remorse” on one big purchase, etc.), as opposed to random actions, may emerge during RNG based exploration. An abnormal behavioral pattern may indicate a fraudulent transaction. For example, a simulated customer James Culley may generally make transactions having a transaction amount below $1,000. Suddenly, there is a transaction having a transaction amount of $5,000, and this suspicious transaction may be a fraudulent transaction (e.g., the credit card of James Culley is stolen, or the checking account of James Culley is hacked).

There is a behavioral pattern that naturally emerges or occurs during exploration. For example, as shown in FIG. 3, the simulated customer James Culley received an amount of $12,387.71 in a checking account on Jan. 1, 2014. James Culley spent $474.98 on Jan. 3, 2014, $4,400 on January 3, and $3,856.55 on Jan. 4, 2014 through a debit card associated with the checking account. In the next Month, James Culley received an amount of $12,387.71 in the checking account on Feb. 1, 2014. James Culley spent $4,500 on Feb. 2, 2014, and $1,713.91 on February 3 through the debit card associated with the checking account, and transferred $8,100 out of the checking account on Jun. 27, 2014. In this example, this simulated customer James Culley has a tendency of save-and-spend, and occasionally has a big purchase. The behavioral pattern makes this simulated customer James Culley behave more realistically (i.e., look more like a real customer, rather than a robot). A plurality of parameters, such as “behavioral consistency” (the degree of behavioral consistency in a period of time), “consistency volatility” (frequency of behavior change), “behavior abnormality” (deviation from regular transaction behaviors), etc., are generated according to the policy engine 206, and used to show a different personality or behavioral pattern or emergent properties of each simulated customer.

In one or more embodiments, a trained intelligent agent is paired to an actual person (customer); the paired trained intelligent agent simulates or predicts new transaction records for a simulated customer (or clustered customer); the transactions (behavior) of the paired actual person (customer) is compared to the predicted new transaction records by the intelligent agent; and transactions by the paired actual person (customer) that are inconsistent with the predicted new transaction records by the paired intelligent agent are flagged for review. The method and/or approach to detecting suspicious activity in one or more embodiments capitalizes on existing infrastructure (e.g., trained agent models on clustered behavior groups) developed to simulate customer behavior and transactions, including simulated data across a consortium of organizations. In an aspect, existing infrastructure, e.g., trained intelligent agents are run to predict transactions of a simulated customer (or clustered group of customers) in parallel with current customer activity, as opposed to the intelligent agent generating new customers. Confidence scores, levels or intervals of actual customer transactions (behavior) in one or more embodiments are compared to confidence scores, levels, or intervals of the predicted/simulated transactions (behavior) generated by the intelligent agent to determine thresholds for preparing, generating, and or sending alerts.

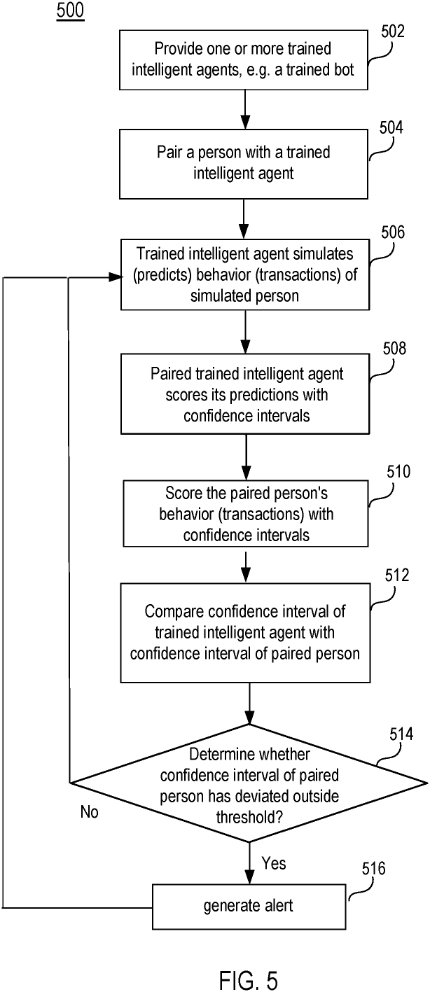

FIG. 5 illustrates a flow chart of one illustrative embodiment showing a method 500 of identifying a suspicious behavioral pattern, e.g., generating an alert as to potential suspicious activity. Referring to FIG. 1 and FIG. 5, in one or more embodiments, one or more trained intelligent agents are provided at 502. The trained intelligent agents can be provided according to the method 400 of FIG. 4, or according to a number of different methods and techniques. The process 500 is not limited by the manner in which the intelligent agent is trained or provided. Each trained agent is intended to predict and/or simulate transactional activity, e.g., financial transactional activity, of a simulated person (or clustered person), e.g., a simulated customer (or simulated clustered customer).

At 504, in an embodiment, a person, e.g., a customer, is paired with a trained intelligent agent, e.g., a trained bot. In one or more embodiments, the Behavioral Pattern Comparator 112, and/or the Transaction Data Simulator 110, pairs a trained intelligent agent to a person (e.g., a customer). In an embodiment, persons are clustered via hyper-dimensional clustering to form a representative person and the representative person is paired with a trained intelligent agent at 502. A person can be an actual person (customer) and/or a representative person (customer). The trained intelligent agent is paired with a person preferably in a manner such that the simulated transactional activity generated by its simulated person corresponds with and/or is intended to match or closely match the transactional activity (e.g., the behavior) of the person to which it is paired. In an aspect, each person has a trained intelligent agent running in parallel with each person. In one or more embodiments, the hyper-dimensional clustering of the persons can occur in the Transaction Data Simulator 110 and the pairing of the persons to a trained intelligent agent can take place in the Behavior Pattern Comparator 112, although the disclosed actions and/or functions can occur entirely in the Transaction Data Simulator 110 and/or the Behavior Pattern Comparator 112. The paired person in an embodiment can be an actual person (e.g., customer) paired with an intelligent agent, or in an aspect can be a clustered or representative person (e.g., customer) paired with a trained intelligent agent.

At 506 the paired trained intelligent agent simulates the transactions (behavior) of the paired person. That is, in an embodiment, the paired, trained intelligent agent runs and predicts the anticipated transactions (behavior0 of its simulated person. In one or more embodiments, the trained intelligent agent runs and simulates and/or predicts transactions (behavior) of its simulated person over a measured period, for example a period of time, a number of transactions, or a combination of a period of time and a number of transactions. The transactions (behavior) of the simulated person predicted by the paired intelligent agent in one or more embodiments is intended to represent the anticipated transactions (behavior) of the paired person, including for example, whether the simulated person would undertake any transactions for the measured period. For example, each day the paired trained agent steps through, e.g., undertakes, a day’s worth of simulated/predicted activity (transactions), including determining whether any transactions would be undertaken in that day. The predicted transactions taken for the measured period, e.g., the day, includes whether any transactions would occur for the measured period, and if so, all the information needed to generate the transactions taken for the measured period, such as, for example, how many transactions are generated in the measured (time) period; and for each transaction the type, amount, time, location and medium of the transaction. Simulating and/or predicting the transactions (e.g., behavior) of the simulated person by the paired, trained intelligent agent, in an aspect, preferably is performed in the Transaction Data Simulator 110.

At 508, the paired, trained intelligent agent scores its predictions of simulated transactional activity of the simulated person. In an aspect, the paired, trained intelligent agent scores its predictions with a confidence score and/or at a confidence level. In one or more embodiments, the confidence score of the paired, trained intelligent agent represents a probability or likelihood that the predicted/simulated transactions (behavior) of the simulated person generated by the paired, trained intelligent agent will be performed. For example, the predicted transactions generated by the paired, intelligent agent could be a confidence score and/or confidence level represented by a numerical score, e.g., an 89, or a numerical range, e.g., 85-89, a percentage, e.g., 89%, a range of percentages, e.g., 85%-90%, or a level, e.g., high, medium, or low. In one or more embodiments, the paired, trained intelligent agent scores its predictions based upon the time period, e.g., the paired, trained intelligent agent scores its predictions at the end of the time period, for example, at the end of each day. In an aspect, the paired, trained intelligent agent at the end of the day scores its predictions of the transactional activities of the simulated person with confidence intervals.

At 510, the behavior of the paired person, e.g., an actual customer, is also scored, e.g., scored with a confidence score, a confidence level, and/or a confidence interval. For example, the confidence can be a numeric score, for example “89”; a confidence level out of categories of low, medium, or high; based upon confidence intervals, expressed for example as percentage intervals (50% - 60%, 60% - 70%, etc.); or any other manner of scoring the confidence score of the paired person. In one or more embodiments, the transactional activity of the person (e.g., actual customer) is scored using the paired intelligent agent’s policy engine. In one or more embodiments, the confidence score of the actual person as scored by the policy engine of the paired, trained intelligent agent represents a probability or likelihood that the transaction(s) of the actual person (customer) would have been performed. The transactional activity of the paired person in one or more aspects is scored for a measured period, and in an embodiment is scored using the paired, trained intelligent agent’s policy engine. In one or more embodiments, the measured period over which the transactional activity of the paired person is measured is the same measured period as the paired, trained intelligent agent. In one or more embodiments, the transactional activity of the paired actual person is scored over a measured period, e.g., a day, with a confidence score and/or at a confidence level.

At 512 the confidence score and/or confidence interval of the actual person is compared to the confidence score and/or confidence level of the simulated customer of the paired trained intelligent agent. At 514, it is determined whether the confidence score and/or confidence level of the actual paired person has deviated from the confidence score and/or confidence level of the simulated person (or clustered person) of the paired trained intelligent agent. In one or more embodiments, at 514, it is determined whether the confidence score and/or confidence level of the paired actual person (customer) has deviated a threshold, e.g., at least a threshold, from the confidence score and/or confidence level of the simulated person (or simulated clustered person) of the paired trained intelligent agent. In an aspect, the threshold is a risk threshold, and it can in an embodiment be determined by the financial institution’s risk policy. The threshold can be fixed, predetermined, predefined, selectable, adjustable, programmable, and/or machine learned.

If at 514, the confidence score and/or level of the actual person is not outside the threshold (514: No), then process 500 continues back to 506 where the paired trained intelligent agent simulates the transactional activity of the paired person in an aspect for another measured period. In an embodiment, if at 514, the difference between the confidence level of the paired actual person (customer) and the confidence score and/or confidence level of the predicted or simulated transactional activity produced by the paired trained intelligent agent are not outside (e.g., is within) the threshold (514: No), then the process 500 continues back to 506, where the process 500 continues to monitor the financial activity of the paired person. For example, if the threshold is 10%, and the difference between the confidence score of the actual person (customer) and the confidence score of the paired, trained intelligent agent is less than 10%, e.g., 9.5%, then the process continues its monitoring process, in an embodiment without generating an alert. In an alternative embodiment, an alert or report can be generated after each measured period providing for example the deviation score for the customer.

If at 514, the confidence score and/or level of the paired actual person (customer) is outside the threshold (514: Yes), then at 516 an alert and/or report is generated. In an embodiment, if at 514, the difference between the confidence level of the paired actual person (customer) and the confidence score and/or confidence level of the simulated person of the paired trained intelligent agent is outside the threshold (514: Yes), then at 516 an alert is generated. The alert or report generated can flag the person (customer), and/or provide particulars on the transactional activity that resulted in the alert, and/or other additional information that could be helpful to further investigate. The process 500 at 516 can optionally continue back to 506 and continue to monitor the financial activity of the paired actual person, where the paired trained intelligent agent simulates the behavior of the paired person, in an aspect, for another measured (e.g., time) period.

It can be appreciated that in the method 500 of FIG. 5 that the trained intelligent agent can be paired with an actual person, or in an embodiment with a representative person and that the representative person in an aspect can be based upon a clustered group of persons. In such an embodiment, 510, 512, and 514 will be based upon the representative person.

The Transaction Data Simulator 110 can use abstracted or aggregated real transactional data to simulate data that is representative of real customers. The Transaction Data Simulator 110 can provide a large set of simulated customer data (i.e., simulated transaction data in combination with an artificial customer profile) that can be used to train a predictive model, e.g., an intelligent agent, to predict customer behavior, or any number of analytics used in the detection and prevention of financial crimes. Further, the simulated customer data can be generated based on abstracted data of the real raw customer data, rather than the real raw customer data itself, and in one or more embodiments the simulated customer data renders it difficult to derive actual transaction actions of any real customer to minimize exposing the identify of customers and their transaction data. Additionally, the Transaction Data Simulator 110 allows generation of a behavioral pattern for each simulated customer during iterations.

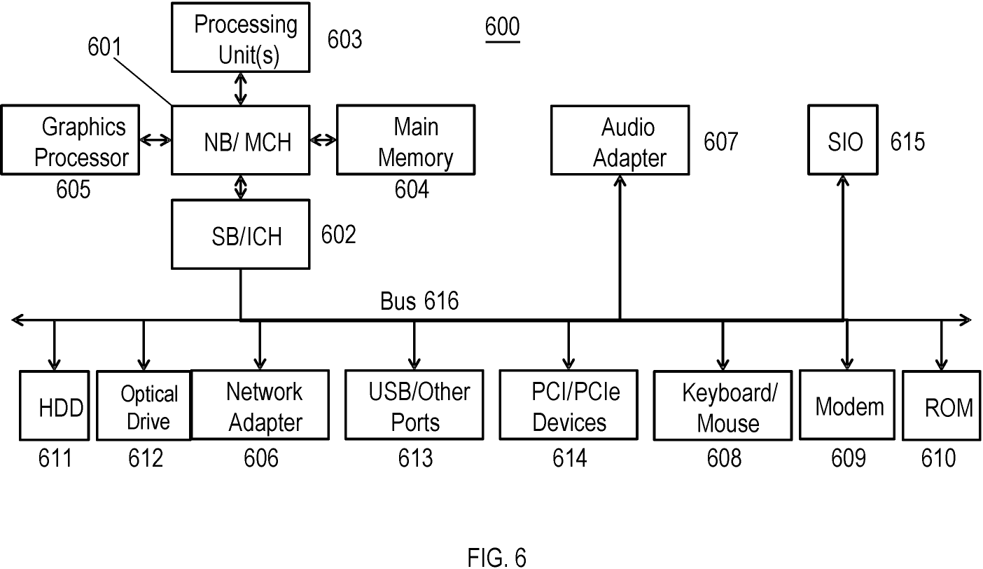

FIG. 6 is a block diagram of an example data processing system 600 in which aspects of the illustrative embodiments are implemented. Data processing system 600 is an example of a computer, such as a server or client, in which computer usable code or instructions implementing the process for illustrative embodiments of the present invention are located. In one embodiment, FIG. 6 represents a server computing device, such as a server, which implements the cognitive system 100 described herein.

In the depicted example, data processing system 600 can employ a hub architecture including a north bridge and memory controller hub (NB/MCH) 601 and south bridge and input/output (I/O) controller hub (SB/ICH) 602. Processing unit 603, main memory 604, and graphics processor 605 can be connected to the NB/MCH 601. Graphics processor 605 can be connected to the NB/MCH 601 through, for example, an accelerated graphics port (AGP).

In the depicted example, a network adapter 606 connects to the SB/ICH 602. An audio adapter 607, keyboard and mouse adapter 608, modem 609, read only memory (ROM) 610, hard disk drive (HDD) 611, optical drive (e.g., CD or DVD) 612, universal serial bus (USB) ports and other communication ports 613, and PCI/PCIe devices 614 may connect to the SB/ICH 602 through bus system 616. PCI/PCIe devices 614 may include Ethernet adapters, add-in cards, and PC cards for notebook computers. ROM 610 may be, for example, a flash basic input/output system (BIOS). The HDD 611 and optical drive 612 can use an integrated drive electronics (IDE) or serial advanced technology attachment (SATA) interface. A super I/O (SIO) device 615 can be connected to the SB/ICH 602.

An operating system can run on processing unit 603. The operating system can coordinate and provide control of various components within the data processing system 600. As a client, the operating system can be a commercially available operating system. An object-oriented programming system, such as the Java™ programming system, may run in conjunction with the operating system and provide calls to the operating system from the object-oriented programs or applications executing on the data processing system 600. As a server, the data processing system 600 can be an IBM^{®} eServer™ System p^{®} running the Advanced Interactive Executive operating system or the LINUX^{®} operating system. The data processing system 600 can be a symmetric multiprocessor (SMP) system that can include a plurality of processors in the processing unit 603. Alternatively, a single processor system may be employed.

Instructions for the operating system, the object-oriented programming system, and applications or programs are located on storage devices, such as the HDD 611, and are loaded into the main memory 604 for execution by the processing unit 603. The processes for embodiments of the cognitive system 100, described herein, can be performed by the processing unit 603 using computer usable program code, which can be located in a memory such as, for example, main memory 604, ROM 610, or in one or more peripheral devices.

A bus system 616 can be comprised of one or more busses. The bus system 616 can be implemented using any type of communication fabric or architecture that can provide for a transfer of data between different components or devices attached to the fabric or architecture. A communication unit such as the modem 609 or the network adapter 606 can include one or more devices that can be used to transmit and receive data.

Those of ordinary skill in the art will appreciate that the hardware depicted in FIG. 6 may vary depending on the implementation. Other internal hardware or peripheral devices, such as flash memory, equivalent non-volatile memory, or optical disk drives may be used in addition to or in place of the hardware depicted. Moreover, the data processing system 600 can take the form of any of a number of different data processing systems, including but not limited to, client computing devices, server computing devices, tablet computers, laptop computers, telephone or other communication devices, personal digital assistants, and the like. Essentially, data processing system 600 can be any known or later developed data processing system without architectural limitation.

The system and processes of the figures are not exclusive. Other systems, processes, and menus may be derived in accordance with the principles of embodiments described herein to accomplish the same objectives. It is to be understood that the embodiments and variations shown and described herein are for illustration purposes only. Modifications to the current design may be implemented by those skilled in the art, without departing from the scope of the embodiments. As described herein, the various systems, subsystems, agents, managers, and processes can be implemented using hardware components, software components, and/or combinations thereof. No claim element herein is to be construed under the provisions of 35 U.S.C. 112 (f), unless the element is expressly recited using the phrase “means for.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a head disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java™, Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer, or entirely on the remote computer or server. In the latter scenario, the remote computer may be connected to the user’s computer through any type of network, including LAN or WAN, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatuses (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations steps to be performed on the computer, other programmable apparatus, or other device to produce a computer implemented process, such that the instructions which execute on the computer, other programmable apparatus, or other device implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical functions. In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor, functional units of a processor, or computer implemented system, and logic integrated with and/or executable by the system, processor, or functional units, the logic being configured to perform one or more of the process steps cited herein. What is meant by integrated with is that in an embodiment the functional unit or processor has logic embedded therewith as hardware logic, such as an application specific integrated circuit (ASIC), a field programmable gate array (FPGA), etc. By executable by the functional unit or processor, what is meant is that the logic in an embodiment is hardware logic; software logic such as firmware, part of an operating system, part of an application program; etc., or some combination of hardware or software logic that is accessible by the functional unit or processor and configured to cause the functional unit or processor to perform some functionality upon execution by the functional unit or processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above. If will be further appreciated that embodiments of the present invention may be provided in the form of a service deployed on behalf of a customer to offer a service on demand.

The terminology used herein is for the purpose of describing particular embodiments only and is not intended to be limiting of the invention. Unless otherwise specifically defined herein, all terms are to be given their broadest possible interpretation including meanings implied from the specification as well as meanings understood by those skilled in the art and/or as defined in dictionaries, treatises, etc. The present description and claims may make use of the terms “a,” “at least one of,” and “one or more of,” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all elements in the claims below are intended to include any structure, material, or act for performing the function in combination with other claimed elements as specifically claimed.

The description of the present invention has been presented for purposes of illustration and description, but is not intended to be exhaustive or limited to the invention in the form disclosed. In addition, it should be appreciated that the following description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the example provided herein without departing from the spirit and scope of the present invention.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

1. A computer implemented method in a data processing system comprising a processor and a memory comprising instructions, which are executed by the processor to cause the processor to implement the method for identifying an action that deviates from simulated transaction data in a transaction data network, the method comprising:
providing, by the processor, one or more trained intelligent agents having a policy engine to predict simulated transaction data of one or more simulated persons, wherein the trained intelligent agent is trained by:
providing, by the processor, standard transaction data representing a group of customers having similar transaction characteristics as a goal;
performing, by the processor, a plurality of iterations to simulate the standard transaction data, wherein the plurality of iterations is performed until a degree of similarity of simulated transaction data relative to the standard transaction data is higher than a first predefined threshold; and
in each iteration:
conducting, by the intelligent agent, an action including a plurality of simulated transactions;
comparing, by an environment, the action with the goal;
providing, by the environment, a feedback associated with the action based on a degree of similarity relative to the goal; and
adjusting, by the policy engine, a policy based on a the feedback;
pairing, by the processor, a person to one of the one or more trained intelligent agents based upon actual transaction data of the person;
predicting, by the paired trained intelligent agent, simulated transaction data of a simulated person for a measured period;
scoring, by the processor, the simulated transaction data of the simulated person for the measured period;
scoring, by the processor, the actual transaction data undertaken by the paired person for the measured period;
determining, by the processor, if the score of the simulated transaction data of the simulated person for the measured period is different than the score of the actual transaction data undertaken by the paired person for the measured period; and
generating by the processor, in response to determining that the score of the simulated transaction data of the simulated person for the measured period is different than the score of the actual transaction data undertaken by the paired person for the measured period, a report identifying the actual transaction data that deviates from the predicted simulated transaction data in the transaction data network.

2. The method as recited in claim 1, wherein the person paired to one of the trained intelligent agents is a representative person, wherein the representative person comprises a plurality of actual persons that are clustered based upon the actual transaction data of the plurality of actual persons via hyper-dimensional clustering.

3. The method as recited in claim 1, wherein the measured period is at least one of the group consisting of a time period, a number of transactions, and a combination thereof.

4. The method recited in claim 3, wherein the measured period is twenty-four hours.

5. The method as recited in claim 1, wherein scoring the simulated transactional activity of the simulated person for the measured period and scoring the actual transaction data undertaken by the paired person for the measured period are performed using the policy engine of the paired intelligent agent.

6. The method as recited in claim 1, wherein determining if the score of the simulated transaction data of the simulated person for the measured period is different than the score of the actual transaction data undertaken by the paired person for the measured period comprises comparing, by the processor, the score of the simulated transaction data of the simulated person for the measured period to the score of the actual transaction data undertaken by the paired person for the measured period.

7. The method as recited in claim 1, wherein determining if the score of the simulated transaction data of the simulated person for the measured period is different than the score of the actual transaction data undertaken by the paired person for the measured period comprises determining, by the processor, if the score of the simulated transaction data of the simulated person for the measured period is different by at least a threshold from the score of the actual transaction data undertaken by the paired person for the measured period.

8. The method as recited in claim 7, wherein the threshold is at least one of the group consisting of: a selectable threshold, a programmable threshold, an adjustable threshold, a fixed threshold, a predefined threshold, a predetermined threshold, and combinations thereof.

9. The method as recited in claim 8, wherein the threshold is a risk threshold determined by an organization’s risk policy.

10. The method as recited in claim 1, wherein scoring the simulated transaction data of the simulated person for the measured period comprises scoring, by the processor, the simulated transaction data of the simulated person for the measured period in confidence levels.

11. The method as recited in claim 10, wherein scoring the actual transaction data undertaken by the paired person for the measured period comprises scoring, by the processor, the actual transaction data undertaken by the paired person for the measured period in confidence levels.

12. The method as recited in claim 11, wherein determining if the score of the simulated transaction data of the simulated person for the measured period is different than the score of the actual transaction data undertaken by the paired person for the measured period comprises comparing, by the processor, the confidence level of the simulated transaction data of the simulated person for the measured period to the confidence level of the actual transaction data undertaken by the paired person for the measured period, and determining if the confidence level of the simulated transaction data of the simulated person deviates from the confidence level of the actual transaction data undertaken by the paired person.

13. The method as recited in claim 12, wherein determining if the confidence level of the simulated transaction data of the simulated person for the measured period deviates from the confidence level of the actual transaction data undertaken by the paired person for the measured period, comprises determining, by the processor, if the confidence level of the simulated transaction data of the simulated person for the measured period deviates from the confidence level of the actual transaction data undertaken by the paired person for the measured period by at least a threshold, wherein the threshold is a function of a risk policy of an organization.

14. The method as recited in claim 1, wherein after determining if the score of the simulated transaction data of the simulated person for the measured period is different than the score of the actual transaction data undertaken by the paired person for the measured period, the method further comprises:
predicting, by the paired trained intelligent agent, the simulated transaction data of the simulated person for a second measured period;
scoring, by the processor, the simulated transaction data of the simulated person for the second measured period;
scoring, by the processor, the actual transaction data undertaken by the paired person for the second measured period;
determining, by the processor, if the score of the simulated transaction data of the simulated person for the second measured period is different than the score of the actual transaction data undertaken by the paired person for the second measured period; and
generating by the processor, in response to determining that the score of the simulated transaction data of the simulated person for the second measured period is different than the score of the actual transaction data undertaken by the paired person for the second measured period, a report identifying the actual transaction data that deviates from simulated transaction data in the transaction data network.

15. A computer program product for identifying an event that deviates from simulated transaction data in a transaction data network, the computer program product comprising a non-transitory computer readable storage medium having program instructions embodied therewith, the program instructions executable by a processor to cause the processor to:
pair a person to a trained intelligent agent having a policy engine based upon actual transaction data of the person, wherein the trained intelligent agent is configured to predict simulated transaction data of a simulated person, wherein the trained intelligent agent is trainable by:
providing standard transaction data representing a group of customers having similar transaction characteristics as a goal;
performing a plurality of iterations to simulate the standard transaction data, wherein the plurality of iterations is performed until a degree of similarity of simulated transaction data relative to the standard transaction data is higher than a first predefined threshold; and
in each iteration:
conducting, by the intelligent agent, an action including a plurality of simulated transactions;
comparing, by an environment, the action with the goal;
providing, by the environment, a feedback associated with the action based on a degree of similarity relative to the goal; and
adjusting, by the policy engine, a policy based on a the feedback;
predict, by the paired trained intelligent agent, simulated transaction data of the simulated person for a measured period;
score the predicted simulated transaction data of the simulated person for the measured period;
score the actual transaction data undertaken by the paired person for the measured period;
determine if the score of the predicted simulated transaction data of the simulated person for the measured period is different than the score of the actual transaction data undertaken by the paired person for the measured period; and
generate, in response to determining that the score of the predicted simulated transaction data of the simulated person for the measured period is different than the score of the actual transaction data undertaken by the paired person for the measured period, a report identifying the event that deviates from the simulated transaction data in the transaction data network.

16. The computer program product as recited in claim 15, wherein the program instructions executable by the processor to cause the processor to score the predicted simulated transaction data of the simulated person for the measured period and score the actual transaction data undertaken by the paired person for the measured period further comprise programming instructions executable by the processor to cause the processor to score the predicted simulated transaction data and the actual transaction data using the policy engine of the paired intelligent agent; and the measured period is configured to be a time period.

17. The computer program product as recited in claim 15, wherein the program instructions executable by the processor to cause the processor to determine if the score of the predicted simulated transaction data of the simulated person for the measured period is different than the score of the actual transaction data undertaken by the paired person for the measured period comprises programming instructions executable by the processor to cause the processor to:
score a confidence level of the predicted simulated transaction data of the simulated person for the measured period;
score a confidence level of the actual transaction data undertaken by the paired person for the measured period, wherein the scoring of the actual transaction data of the paired person for the measured period is performed by the policy engine of the paired intelligent agent;
determine whether the confidence level of the predicted simulated transaction data of the simulated person for the measured period deviates from the confidence level of the actual transaction data undertaken by the paired person by at least a threshold, wherein the threshold is a function of a risk policy of an organization; and
generate, in response to determining that the confidence level of the predicted simulated transaction data of the simulated person for the measured period deviates from the confidence level of the actual transaction data undertaken by the paired person customer by a threshold,the report identifying the event that deviates from the simulated transaction data in the transaction data network.

18. Currently Amended The computer program product as recited in claim 15, further comprises programming instructions executable by the processor to cause the processor to, after determining if the score of the predicted simulated transaction data of the simulated person for the measured period is different than the score of the actual transaction data undertaken by the paired person for the measured period,:
predict, by the paired trained intelligent agent, the simulated transaction data of the simulated person for a second measured period;
score the predicted simulated transaction data of the simulated person for the second measured period;
score the actual transaction data undertaken by the paired person for the second measured period;
determine if the score of the predicted simulated transaction data of the simulated person for the second measured period is different than the score of the actual transaction data undertaken by the paired person for the second measured period; and
generate, in response to determining that the score of the predicted simulated transaction data of the simulated person for the second measured period is different than the score of the actual transaction data undertaken by the paired person for the second measured period,the report identifying the event that deviates from the simulated transaction data in the transaction data network.

19. A system for identifying an action that deviates from predicted simulated transaction data in a transaction data network , the system comprising:
a non-transitory computer readable storage medium having program instructions embodied therewith; and
a processor configured to execute the program instructions to cause the processor to:
provide one or more trained intelligent agents to predict simulated transaction data of one or more simulated persons, wherein each trained intelligent agent comprises a policy engine and is configured to predict simulated transaction data of a simulated person, wherein the trained intelligent agent is trained by:
providing, by the processor, standard transaction data representing a group of customers having similar transaction characteristics as a goal;
performing, by the processor, a plurality of iterations to simulate the standard transaction data, wherein the plurality of iterations is performed until a degree of similarity of simulated transaction data relative to the standard transaction data is higher than a first predefined threshold; and
in each iteration:
conducting, by the intelligent agent, an action including a plurality of simulated transactions;
comparing, by an environment, the action with the goal;
providing, by the environment, a feedback associated with the action based on a degree of similarity relative to the goal; and
adjusting, by the policy engine, a policy based on a the feedback;
pair a person to a trained intelligent agent based upon the actual transaction data of the person;
predict, by the paired trained intelligent agent, the simulated transaction data of the simulated person for a time period;
score the predicted simulated transaction data of the simulated person for the time period;
score the actual transaction data undertaken by the paired person for the time period, wherein scoring the actual transaction data by the paired person for the time period is performed by the policy engine of the intelligent agent that is paired to the paired person;
determine if the score of the predicted simulated transaction data of the simulated person for the time period is different than the score of the actual transaction data undertaken by the paired person for the time period;
and
generate, in response to determining that the score of the predicted simulated transaction data of the simulated person for the time period is different than the score of the actual transaction data undertaken by the paired person for the time period, a report identifying the transaction that deviates from the predicted simulated transaction data in the transaction data network.

20. The system of claim 19, wherein the program instructions executable by the processor further cause the processor to:
determine if the score of the predicted simulated transaction data of the simulated person for the time period is different than the score of the actual transaction data undertaken by the paired person for the time period comprises:
score a confidence level for the predicted simulated transaction data of the simulated person for the time period;
score a confidence level for the actual transaction data undertaken by the paired person for the time period;
determine whether the confidence level of the predicted simulated transaction data of the simulated person for the time period deviates from the confidence level of the actual transaction data undertaken by the paired person by at least a threshold, wherein the threshold is a function of a risk policy; and
generate, in response to determining that the confidence level of the predicted simulated transaction data of the simulated person for the time period deviates from the confidence level of the actual transaction data undertaken by the paired person by at least a threshold, the report.
